(19) United States
(12) Patent Application Publication
(10) Pub. No.: US 2005/0060720 A1
(43) Pub. Date: Mar. 17, 2005

(54) Calendar alarms via session initiation protocol event packages

(76) Inventor: Georg Mayer, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/662,057

(22) Filed: Sep. 12, 2003

(51) Int. Cl. G06F 9/46

(52) U.S. Cl. 719/318

(57) ABSTRACT

A method is presented for a user to receive an alarm about a pending calendar event, or an overdue to-do, from an electronic calendar system that serves the user. The user accesses a network that connects the user terminal to a calendar system. The user sends a subscribe request for alarms, and then the user receives a notification in response to the subscribe request, to notify the user about at least one alarm that was already triggered before the user accessed the network. This way, the user will obtain alarms that were triggered while the user was inaccessible, instead of missing the alarms altogether. This system includes a user terminal for accessing the network and sending a subscribe request signal, as well as a calendaring unit that is responsive to the subscribe request signal, and is for providing to the user terminal a notification signal indicating alarms that were already triggered before the network was accessed by the user terminal. While the user has access to the network, the user will receive additional alarms in compliance with the subscribe request.

### TECHNICAL FIELD OF THE INVENTION

The invention relates to electronic calendars, and more particularly procedures for finding out about alarms regarding upcoming events or deadlines.

### BACKGROUND ART

Calendaring is the process of keeping track of appointments, tasks, and the like. Scheduling means getting all participants to agree on what appointments and tasks they will insert into their calendars. To achieve a uniform system for calendaring and scheduling, the Internet Engineering Task Force (IETF) created a calendaring and scheduling workgroup (CALSCH WG) that has published numerous Requests for Comments (RFCs) on this subjects. The standard format was established in November of 1998 by RFC 2445, titled “Internet Calendaring and Scheduling Core Object Specification (iCalendar).” The iCalendar functionality allows people to share and coordinate their calendar over the internet, even when the people are in different time zones and/or use different calendaring programs.

Various features of iCalendar have been implemented using Session Initiation Protocol (SIP), which is an application layer protocol at layer seven of the Open Systems Interconnection (OSI). OSI is an internationally accepted framework of standards for communication between different systems made by different vendors. SIP is for the establishment, modification, and termination of conferencing and telephony sessions over an internet protocol (IP) network. SIP is further defined by the Internet Engineering Task Force (IETF), in Request for Comments (RFC) 3261. As thus defined, SIP allows for the establishment, handling and release of end-to-end multimedia sessions. SIP has been employed to provide an interoperability protocol for iCalendar, as discussed in the IETF document “iCalendar SIP-Based Interoperability Protocol” by Pessi and Mela (June, 2003). However, the capabilities of SIP have not yet been fully exploited to support iCalendar.

There have been several additions to the SIP protocol, which for example allow event notification based on SIP, which is the basis for an SIP-based Presence Service and other services. One of these Extensions is the SIP events framework, which is specified in RFC 3265. The SIP events framework allows a user to subscribe to certain type of information (so-called “events”) from a notifier. The information to be reported by a notifier to a subscriber is defined by an event package, and the notifier then sends notifications to the subscriber when the information changes. The SIP events framework leaves the definition of SIP events to the event packages, which are concrete extensions of the SIP events framework. The capabilities of SIP event packages have not yet been adequately exploited or even recognized, with respect to calendaring.

There are three main data structures in iCalendar, and they are event, todo, and journal. The event is a datatype that represents things like appointments, meetings, birthdays, schedules, and the like. The to-do (as in “things to do”) described properties of assignments that a person may have, such as buying a present or getting some exercise. And, the third main data structure journal) refers to logging one's activities in the calendar by making a journal entry.

An iCalendar alarm component is a grouping of component properties that is a reminder or an alarm for an event or a to-do. For example, an alarm component may be used as a reminder for a pending event or an overdue to-do. This alarm component is described in Section 4.6.6 of RFC 2445, titled “Internet Calendaring and Scheduling Core Object Specification (iCalendar).” The capabilities of SIP event packages have not yet been applied, or even recognized, with respect to these calendar-related alarms.

SIP event packages extend or modify basic event package behavior. However, event packages will not succeed if they weaken certain core aspects of basic behavior, even though such aspects can be strengthened or supplemented. There is a set of specific issues that must be addressed by the inventor of an event package, and this has been achieved by various concrete “event package” extensions of the general SIP events framework. These prior art event packages have made use of SIP's “SUBSCRIBE” and “NOTIFY” functions, while addressing the specific issues that must be addressed by an event package inventor. See, for example, “A Presence Event Package for the Session Initiation Protocol (SIP) by J. Rosenberg (IETF Internet Draft). Nevertheless, an SIP event package for calendar alarms has not heretofore been accomplished. A need exists for users to become aware of alarms as they become available, using the SIP events framework.

Calendar information is nowadays usually kept in a centralized place in the network (e.g. in an Outlook Express Server). This information can be stored locally on a device whenever the device synchronizes with the server application. There are devices such as a laptop on which, in offline mode, information about events and alarms might be changed, and such a device is typically not online during a meeting or a business trip. These devices require proper synchronization with the centralized server.

On the other hand, there are devices such as wireless terminals which offer only a limited amount of memory and additionally do not need to be synchronized all the time, as they may provide a web-based access to the calendar information on the server. This is only possible as these devices are always online, for example due to a General Packet Radio Service (GPRS) connection.

A problem in these configurations is that the terminal, which holds no local synchronization, will not get informed about alarms and notifications that are set within the calendar, as long as the terminal is not connected to the calendar via the internet. In other words, if a user terminal is either not connected to the internet sometimes, or is connected to the internet but is not at the calendar web site, then there are problems receiving alarms or notifications. The user may miss an alarm, and therefore be unaware about a pending event or an overdue to-do. This problem may not be severe if the alarm is sent by email, but it may be severe if the alarm is sent by audio or display or other non-email method, because audio and display signals will generally not reach the user. Reliance on email alarms is not an adequate solution, because other types of alarms (e.g. audio or display alarms) have been found to be more effective in many circumstances, especially when they are repeated more than once to alert a user of a calendar event.

Section 4.8.6.3 of “Internet Calendaring and Scheduling Core Object Specification” (RFC 2445) describes the trigger property of an iCalendar alarm. This property specifies when an alarm will trigger. If a trigger occurs when the user terminal is inaccessible to the calendaring system, then the user will not receive the alarm according to the prior art, except in the very special case of an email alarm, which of course may eventually reach the user too late to be of any help to the user.

### DISCLOSURE OF THE INVENTION

In the near future, every wireless terminal, and most likely every personal computer (PC) too, will provide a generic SIP stack, which can be used by any kind of application. A protocol stack is basically a collection of modules of software that together combine to produce the software that enables the protocol to work, i.e. to allow communications between dissimilar computer devices. It is called a “stack” because the software modules are piled on top of each other, and the process of communicating typically starts at the bottom of the stack and works up the stack.

The basic SIP functionality is now proposed to be extended in a new way, so that software applications can subscribe to calendar events (alarms) at the server which holds the users calendar information, and this will cause a notification whenever a calendar alarm is available.

A new SIP Event Package should be defined, for example named “calendar.” This event package can advantageously include XML notation for different alarm-related calendar information, such as appointment-type, time of appointment, location, private/public, and additional information about the alarm such as sound to play, text to flash on screen, time in seconds when the notification should be sent before the alarm.

Whenever the terminal becomes available on the network, it initiates the SIP stack by sending a SUBSCRIBE message with the “calendar” tag in the event header to the server holding the user's calendar information. Within the body of the SUBSCRIBE message, more detailed information about the information the user wants to subscribe to can be included, such as a requirement that notifications should only be sent for alarms before 23:00, or notifications should only be sent for private appointments.

Upon receiving the SUBSCRIBE message, the server immediately sends out a 200 OK and an additional NOTIFY. The NOTIFY includes either an empty document, saying that there is no event currently ongoing, or information about the currently ongoing or closest event.

At the moment when a new calendar appointment/alarm occurs, the server will send out a new NOTIFY to the subscriber. The calendar application in the terminal then notifies the user about the current event. It may also provide a link to the (web-based) calendar entry.

It is important to bear in mind that the word “event” is technically being used here in two different senses, because it is also used in these two senses with respect to SIP and calendaring, respectively. In the SIP sense, an “event” refers to some occurrence which requires that a user be notified. In the calendaring sense, an “event” refers to a calendar item that may be pending, in which case an alarm will be triggered. The alarm is the “event” (in the SIP sense) about which a user needs to be notified; an event (in the calendaring sense) that is not pending or imminent will require not event in the SIP sense.

According to one preferred aspect of the present invention, a user receives an alarm about a pending calendar event, or an overdue to-do, from an electronic calendar system that serves the user. This is accomplished by the user accessing a network that connects the user terminal to a calendar system. The user sends a subscribe request for alarms, and then the user receives a notification in response to the subscribe request, in order to notify the user about at least one alarm that was already triggered before the user accessed the network. This way, the user will obtain alarms that were triggered while the user was inaccessible, instead of missing the alarms altogether.

This system includes a user terminal for accessing the network and sending a subscribe request signal, as well as a calendaring unit that is responsive to the subscribe request signal, and is for providing to the user terminal a notification signal indicating alarms that were already triggered before the network was accessed by the user terminal. While the user has access to the network, the user will receive additional alarms in compliance with the subscribe request.

The user terminal of the present invention is for receiving at least one alarm about a pending calendar event, or an overdue to-do, from an electronic calendar system that serves at least the user terminal. The user terminal comprises a network access module, responsive to user input, for providing a subscribe request signal requesting alarms. The terminal also includes a calendar alarm module, responsive to a notification signal indicative of an alarm that was triggered while the user was not connected to the network, and this alarm module provides an alarm to the user. The user terminal also includes a communication module, responsive to the subscribe request signal, for communicating with a network that is connected to the electronic calendar system, and then providing the notification signal to the alarm module.

### BRIEF DESCRIPTION OF THE DRAWINGS

FIG. 1 depicts the method according to one of the preferred embodiments of the present invention.

FIG. 2 shows the system of the present invention according to one of the preferred embodiments, including the user terminal of the present invention.

### BEST MODE FOR CARRYING OUT THE INVENTION

According to a best mode embodiment of the present invention, a user is assisted in receiving an alarm about a pending calendar event, or an overdue to-do, from an electronic calendar system that serves the user. This is accomplished by accessing a network that connects the user to the calendar system. A subscribe request is sent in order to subscribe to the calendar alarms. Then a notification is received in response to the subscribe request, to notify the user about an alarm that was already triggered before the accessing step, or notifying the user that no alarms were triggered. The subscribe request can be sent each time the user terminal accesses the network, or the subscribe request can be sent before the accessing step so as to be applicable for multiple access periods. While the user has access to the network, the user will also be able to receive further notify messages describing alarms that are triggered while the user terminal has that access.

The present subscribe request advantageously utilizes and is formatted based upon a session initiation protocol (SIP), and the notification has content defined by an SIP event package. The further notify message (describing alarms triggered during network access) can be sent substantially simultaneously to the user terminal and at least one other terminal for whom the event is pertinent, but the other notifications (regarding past triggers) are sent only to one terminal which is the user terminal.

The subscribe request of this embodiment is either sent to a centralized calendar server, or to a respective calendar server corresponding to the user terminal.

As is customary for SIP protocols, the sending step and the receiving step are each typically followed substantially immediately by an okay response. The event includes extensible markup language indicative of a type of calendar event, or type of overdue to-do, or indicative of an alarm technique other than an alarm via email. The alarm via email is often not as effective as, for example, a message that flashes repeatedly on the user screen or makes sounds that the user cannot ignore.

The subscribe request is sent with a calendar tag in an event header, and the subscribe request contains information about at least one pending calendar event, or overdue to-do, or type of alarm. In response, the notification contains an internet link to a corresponding calendar entry, so that the user can link directly to the calendar entry.

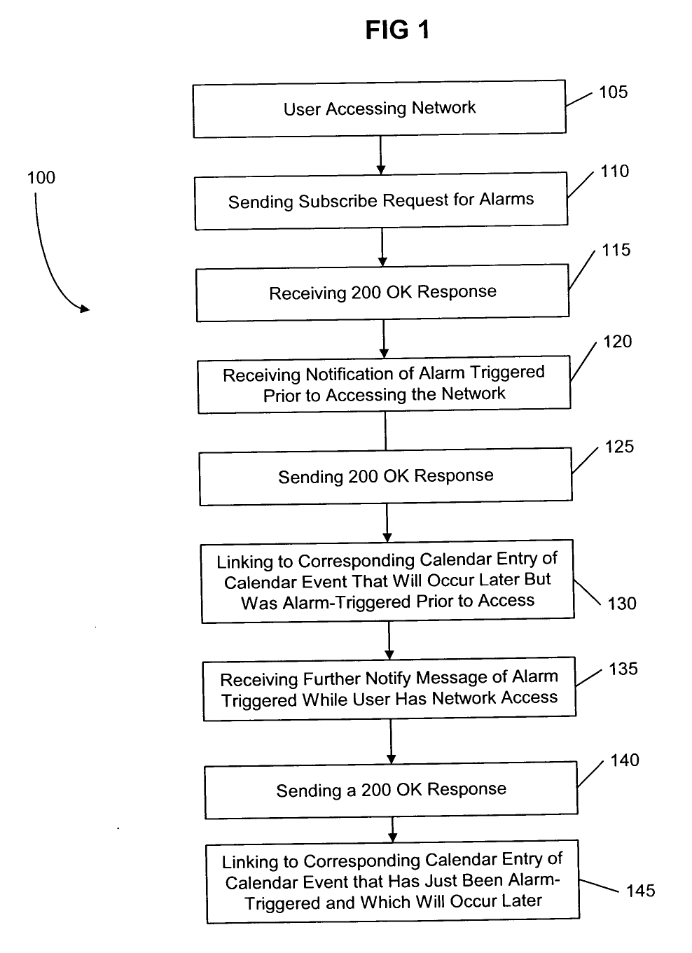

FIG. 1 shows how this method 100 works. The user accesses the network 105, and sends 110 a subscribe request for alarms. This is acknowledged by a 200 OK response 115. Then the user receives notification 120 of an alarm triggered prior to accessing the network. Of course, even though the alarm was triggered prior to access, the calendar event to which the alarm refers can nevertheless occur after the user receives this notification 120. The user terminal acknowledges the notification with a 200 OK response 125. The user can then link 130 to the calendar entry corresponding to the alarm. Subsequently, the user will typically receive further notify messages 135 regarding alarms that triggered while the user has access to the network. Such a notify message will be acknowledged by a 200 OK response 140, and again the user in this embodiment will link 145 to the corresponding calendar entry.

The present invention also, of course, covers software for implementing the method just described. In other words, the present invention includes a computer-readable medium for use in a user terminal, the medium being encoded with a data structure for performing the method.

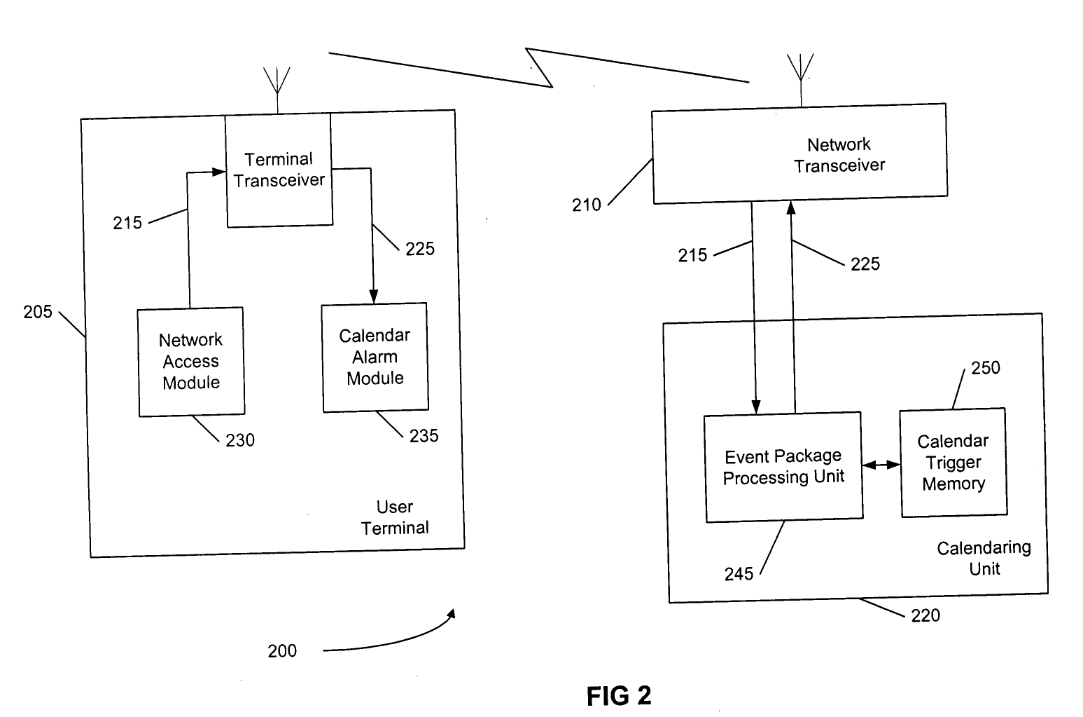

The system of the present invention provides a user with an alarm regarding a pending calendar event, or regarding an overdue to-do, using an electronic calendar that serves the user and that may easily serve others as well. As seen in FIG. 2, the system 200 includes a user terminal 205, for accessing a network having a network transceiver 210. The user terminal sends a subscribe request signal 215 to a calendaring unit 220 that is responsive to the subscribe request signal. The calendaring unit provides to the user terminal 205 a notification signal 225 indicating an alarm that was already triggered before the network was accessed by the user terminal, or indicating that no triggers occurred during that period before access (i.e. the period between user access sessions).

The calendaring unit in this best mode embodiment is a server or terminal connected at least sometimes to the user terminal via the network, and the calendaring unit 220 is also for providing to the user terminal 205 at least one further notify message indicative of an alarm that is triggered while the user terminal has access to the network.

The user terminal 205 of the present invention is for receiving at least one alarm about a pending calendar event, or an overdue to-do, from an electronic calendar system that serves the user terminal. The user terminal 205 includes a network access module 230 which is responsive to user input. For example, the user may program the user terminal to contact the network at regular intervals, or the user may initiate a particular network access attempt.

The network access module 230 provides the subscribe request signal 215 that is transmitted to the calendaring unit 220 in order to requests the alarms. The user terminal also includes a calendar alarm module 235, which is responsive to the notification signal 225 that has been transmitted from the calendaring unit 220. The notification signal 225 indicates alarms that were triggered while the user was not connected to the network, and this calendar alarm module 235 thus provides those alarms to the user that the user would have otherwise have possibly missed.

In the present best mode embodiment, the user terminal is a wireless device, and it includes a communication module (e.g. a terminal transceiver) 240 that is responsive to the subscribe request signal 215, and is for communicating with the network transceiver 210 that is connected to the electronic calendar system or calendaring unit 220, so that the communications module 240 will then provide the notification signal 225 to the alarm module. The calendar alarm module 235 of the user terminal 205 is also responsive to a further notify signal, from the terminal transceiver 240, indicative of an alarm that is triggered while the user terminal has access to the network. The subscribe request 215 defines an event package that is processed by the event package processing unit 245 within the calendaring unit 220. The processing unit 245 checks a calendar trigger memory 250 in order to figure out which triggers occurred while the user had no network access, and this information assists the processing unit 245 in providing the notification signal 225.

It is to be understood that all of the present Figures, and the accompanying narrative discussions of the best mode embodiment, do not purport to be completely rigorous treatments of the method and system under consideration. A person skilled in the art will understand that the steps and signals of the present application represent general cause-and-effect relationships that do not exclude intermediate interactions of various types, and will further understand that the various conceptual elements and structures described in this application can be implemented by a variety of different combinations of hardware and software which need not be further detailed herein and which are all within the scope and spirit of the claims.

1. A method for a user to receive an alarm about a pending calendar event, or an overdue to-do, from an electronic calendar system that serves at least the user, comprising the steps of:
accessing a network that connects a user terminal to the calendar system;
sending a subscribe request for the at least one alarm;
receiving a notification in response to the subscribe request, to notify the user about at least one alarm that was already triggered before the accessing step, or notifying the user that no alarms were triggered.

2. The method of claim 1, wherein the subscribe request is sent each time the user terminal accesses the network, or is sent before the accessing step.

3. The method of claim 1, further comprising the step of receiving at least one further notify message describing an alarm that is triggered while the user terminal has access to the network.

4. The method of claim 1, wherein the subscribe request utilizes and is formatted based upon a session initiation protocol (SIP), and
wherein the notification has content defined by an SIP event package.

5. The method of claim 3, wherein the further notify message is sent substantially simultaneously to the user terminal and at least one other terminal, and
wherein the notification is sent only to one terminal which is the user terminal.

6. The method of claim 1, wherein the subscribe request is sent to a centralized calendar server.

7. The method of claim 1, wherein the subscribe request is sent to a respective server for the calendar corresponding to the user terminal.

8. The method of claim 1, wherein the sending step and the receiving step are each followed substantially immediately by an okay response.

9. The method of claim 4, wherein the event package includes extensible markup language indicative of a type of calendar event, or type of overdue to-do, or indicative of an alarm technique other than an alarm via email.

10. The method of claim 1, wherein the subscribe request is sent with a calendar tag in an event header, and wherein the subscribe request contains information about at least one pending calendar event, or overdue to-do, or type of alarm.

11. The method of claim 1, wherein the notification contains an internet link to a corresponding calendar entry.

12. A computer-readable medium or media for use in a user terminal, the medium being encoded with a data structure for performing the method of claim 1.

13. A system for providing a user with an alarm regarding a pending calendar event, or an overdue to-do, using an electronic calendar that serves at least the user, comprising:
a user terminal, for accessing a network and sending a subscribe request signal; and
a calendaring unit, responsive to the subscribe request signal, for providing to the user terminal a notification signal indicative of at least one alarm that was already triggered before the network was accessed by the user terminal, or indicative that no triggers occurred.

14. The system of claim 13, wherein the calendaring unit is a server or terminal connected at least sometimes to the user terminal via the network, and
wherein the calendaring unit is also for providing to the user terminal at least one further notify message indicative of an alarm that is triggered while the user terminal has access to the network.

15. A user terminal for receiving at least one alarm about a pending calendar event, or an overdue to-do, from an electronic calendar system that serves at least the user terminal, comprising:
a network access module, responsive to user input, for providing a subscribe request signal indicative of a request for the at least one alarm;
a calendar alarm module, responsive to a notification signal indicative of at least one alarm that was triggered while the user was not connected to the network, for providing an alarm to the user; and
a communication module, responsive to the subscribe request signal, for communicating with a network that is connected to the electronic calendar system, and for then providing the notification signal to the alarm module.

16. The user terminal of claim 15, wherein the calendar alarm module is also responsive to a further notify signal, from the communication module, indicative of an alarm that is triggered while the user terminal has access to the network.
